(19) United States
(12) Patent Application Publication
(10) Pub. No.: US 2012/0177789 A1
(43) Pub. Date: Jul. 12, 2012

(54) STAY COOL BAND

(76) Inventor: Christopher Paul Ramsey, Oxfordshire (GB)

(21) Appl. No.: 13/382,451

(22) PCT Filed: Jul. 9, 2010
(86) PCT No.: PCT/EP10/59910

§ 371 Date: Mar. 15, 2012

(51) Int. Cl. B65D 81/38; A47J 41/00; B65B 3/02; B65D 85/72; B21D 51/26

(52) U.S. Cl. 426/131; 426/383; 413/1; 53/452; 220/592.17

(57) ABSTRACT

A method of manufacturing a beverage can body with integral hand insulation band (10) or portions (18). The beverage can body (1) having a base (3) and a sidewall (2) and the insulation portion or portions (10, 18) arranged to separate a user's hand from the sidewall (2) of the can body (1) during use. A filled and sealed beverage can, incorporating the hand insulation band (10) or portions (18) may be heat-treated (e.g. pasteurised) as required during the production process and also may be chilled by a user post-production.

### TECHNICAL FIELD

The present invention relates to method of manufacturing a container for drinks having an integral insulating band or portions and additionally to a metal beverage container containing a drink, which has been cooled. When the cooled can of drink is placed in an ambient environment, the effect of all the heat transfer mechanisms; convection, radiation, conduction and condensation; tend to warm the can and its contents. It turns out that for a standard metal can warming in moist warm air, all the mechanisms have a significant effect. However when the same can is held in a user's hand the over-riding heat transfer mechanism is thermal conduction from the user's hand.

This warming effect is particularly noticeable for metal beverage cans, because metal is a good conductor of heat and because metal beverage cans are often held in a user's hand, whilst the user drinks the contents of the can.

### BACKGROUND ART

An all over insulating label is the obvious solution but has failed in the past, for example the DuPont Cool2Go shrink label technology (used by AmBev) provides a thermally insulating label, which encases the majority of the cylindrical side-wall of a conventional metal beverage can. However, such an all over insulating label makes the can feel like a plastic bottle and is disliked by consumers. The label makes the can feel warm even when the contents of the can are cold, which is counter intuitive. The label also fully insulates the walls of the can making it very difficult to heat-treat e.g. pasteurise, without using high temperature which effects product quality. Finally, it is difficult to apply the label after pasteurising, as the filled cans are wet after being rinsed. WO 97/32797 Dec. 9, 1997 describes just such a full body height wrap, which is post applied after the can body has been filled, the end affixed to the body and the filled can processed.

In order to overcome the issue surrounding processing (such as pasteurising), various insulating wraps are proposed in the prior art for post application to cans, after processing. For example, U.S. Pat. No. 4,268,567 B19 May 1981 U.S. Pat. No. 6,620,281 16 Sep. 2003.

### DISCLOSURE OF INVENTION

The present invention seeks to limit the warming effect when a user holds a can in the hand by provision of an insulating band or portions, which limit conduction of heat from the users hand to the metal can body and contents of the can by providing a localised air gap between the user's hand and the surface of the metal beverage can. The insulating band or portions do not cover the majority of the can body and therefore, the filled can may be processed (e.g. pasteurised) with the insulation (band or portions) in situ and the filled can may be successfully refrigerated, with the insulation in place. Furthermore, as the insulation (band or portions) is pre-applied to the can body, it is unaffected if such processing causes the can to become wet.

Accordingly, the invention provides a method of manufacturing a beverage can body with integral hand insulation band or portions, comprising manufacturing a metal can body having a base, and a sidewall, and affixing an insulation band or portions arranged to separate a user's hand from the sidewall of the can body during use.

Preferably, the insulating band or portions cover a height range of no more than 50-100 mm. The inventors have found that this range is sufficient to accommodate a user's hand, whilst being sufficiently limited to allow adequate heat treatment of the filled cans during manufacture and cooling of the filled beverage cans during use.

The limited coverage of the insulating band relative to the sidewall of the can body has a number of advantages. Fillers may continue to fill the can body with insulating band in-situ using their conventional machines and processes. The limited area of the sidewall of the can body covered by the insulating band or portions leaves a sufficient area of exposed can body for successful heat treatment (such as pasteurisation) of the product inside the filled can body. The insulating band is designed to survive such heat treatment and immersion of the can in water, either during pasteurisation or post manufacture, where the filled can is being chilled in iced water. The insulating band may be adapted to provide drainage channels to allow the can and insulating label to drain quickly after immersion in water. A can body with insulating band or portions is filled and thereafter sealed using a conventional end. The end is affixed to the filled can body using conventional double seaming techniques.

The inventor's have found that users prefer to “feel” the cool can body around the insulation (band or portions) to reinforce their perception that the can is cool. Thus, in contrast to an all over insulating label which may give the user an impression that the contents in the can are “warm”, the exposed portion of the can according to the present invention allows a user to “feel” that the can is chilled.

The breakthrough for the new design comes from research showing that the temperature rise comes largely from the consumer's hand rather than from the environment thus an un-held can warms half as much during 20 minutes (temperature rises from 3 to 8C).

### BRIEF DESCRIPTION OF FIGURES IN THE DRAWINGS

The invention will now be described in more detail, by way of example only, with reference to the accompanying drawings, in which:

FIG. 1 shows a perspective view of a can according to a first embodiment of the invention, having an insulating band of limited height sufficient to accommodate a user's hand;

FIG. 2 is a cross section view through the can of FIG. 1;

FIG. 3 shows a perspective view of a can according to a second embodiment of the invention, having an insulating band that is corrugated;

FIG. 4 is a cross section view through the can of FIG. 3;

FIG. 5 shows a perspective view of a can according to a third embodiment of the invention, having an insulating band which is embossed;

FIG. 6 is a cross section view through the can of FIG. 5;

FIG. 7 shows a perspective view of a can according to a fourth embodiment of the invention, where the can is shaped to define a space between the sidewall of the can body and the band;

FIG. 8 is a cross section view through the can of FIG. 7;

FIG. 9 shows perspective views (front and back) of a can according to a fifth embodiment of the invention, in which the insulating “band” is further limited to finger and thumb portions;

FIG. 10 is a cross section view through the can of FIG. 9.

FIG. 11 shows a perspective view of a can according to a sixth embodiment of the invention having beads which hold the band in position on the can body;

FIG. 12 is a cross section view through the can of FIG. 11 illustrating how the beads may be used to give the can a smoother outer profile;

FIG. 13 shows a perspective view of view of the band shown in FIGS. 11 and 12, which may be affixed to the can body, the band having spacer elements to define a space between the sidewall of the can body and the band.

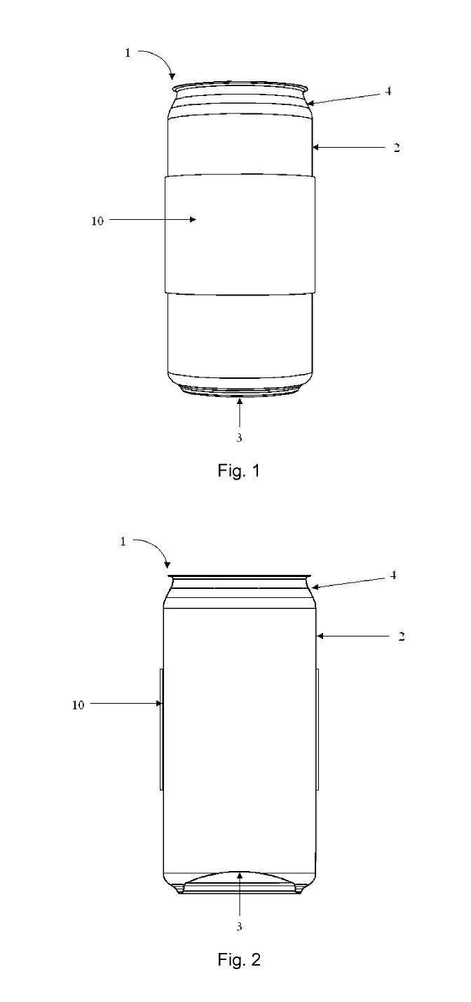

Referring to FIGS. 1 and 2, beverage can body manufactured according to a first embodiment of the invention comprises a can body 1, having a sidewall 2 and a base 3 with a hand insulation band 10, which covers a portion of the sidewall 2 of the can body 1. As illustrated in the figures, the remainder of the sidewall 2 of the can body 1 remains uncovered/exposed. This uncovered/exposed portion of the sidewall 2 is sufficient to allow conventional heat treatment of the contents held inside the can. The can body 1 with affixed hand insulation band 10 is provided to a filler, who may then fill the can body 1, before sealing the filled can with an end, which is fixed to the can body using a conventional process, such as double seaming.

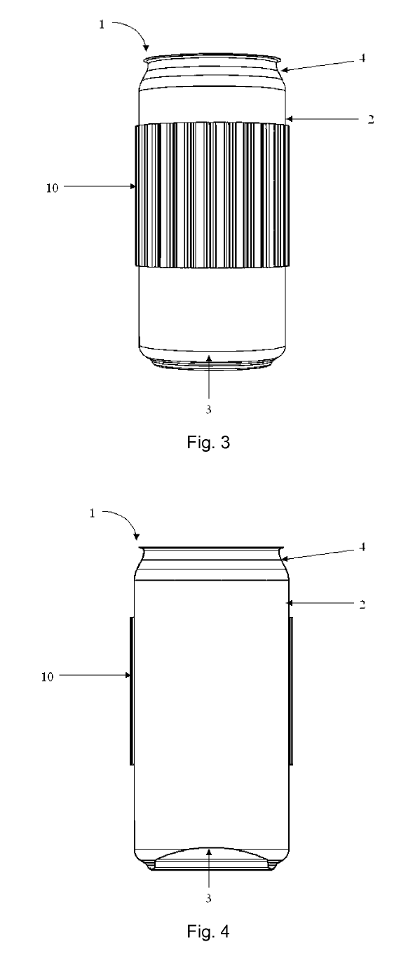

In a second embodiment of the invention (referring to FIGS. 3 and 4) the band 10 is corrugated so that it defines air pockets (not labelled) between the sidewall 2 of the can body 1 and the surface of the band 10 held in a user's hand.

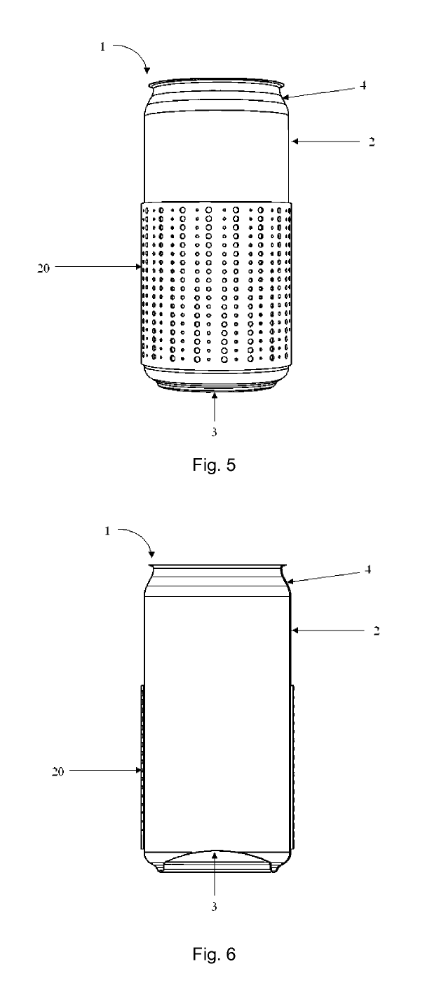

In a third embodiment of the invention (referring to FIGS. 5 and 6) the band 10 is embossed so that it defines air pockets (not labelled) between the sidewall 2 of the can body 1 and the external surface of the band 10 held in a user's hand. Such embossing of consists of a plurality of reduced thickness (dots) provided on the insulating band 10. This will not diminish the “insulating” effect of band 10 providing the dots are sized sufficiently small to prevent a user's hand from directly contacting the sidewall 2 of can body 1.

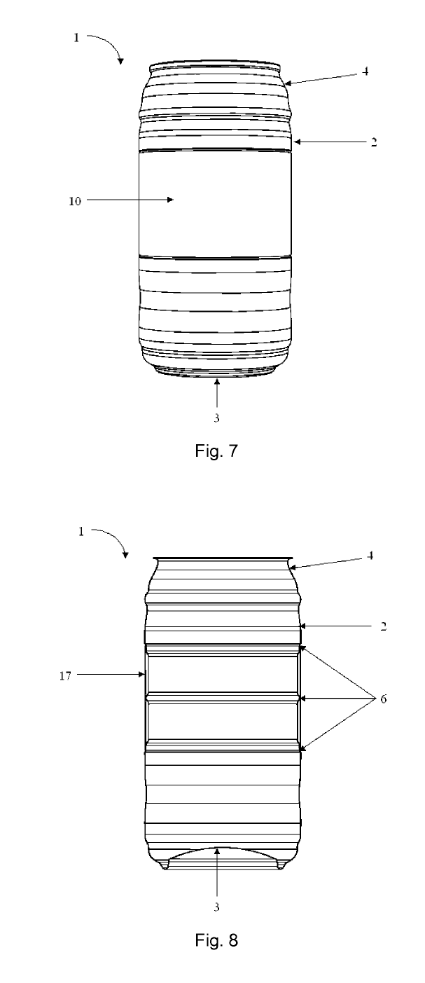

In a fourth embodiment of the invention (referring to FIGS. 7 and 8) the sidewall 2 is shaped so that it defines air pockets (not labelled) between the sidewall 2 of the can body 1 and the surface of the band 10 held in a user's hand. In its simplest form, such shaping may simply be the provision of beads 17 on the sidewall 2 of the can body 1 over which a label 17 is affixed to the can body 1. Alternatively, more complex shaping of the can body 1 may be envisaged by the person skilled in the art, without departing from the teaching of the present invention.

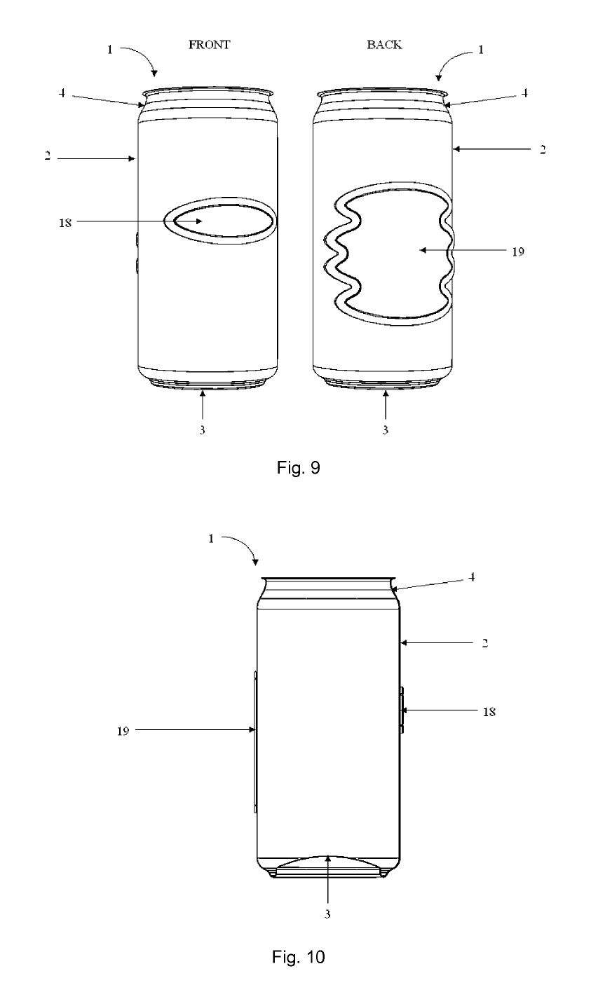

In a fifth embodiment of the invention (referring to FIGS. 9 and 10) the hand “insulation” provided on the can body 1 is restricted to thumb 18 and finger 19 portions, which define air pockets (not labelled) between the sidewall 2 of the can body 1 and a user's thumb and fingers.

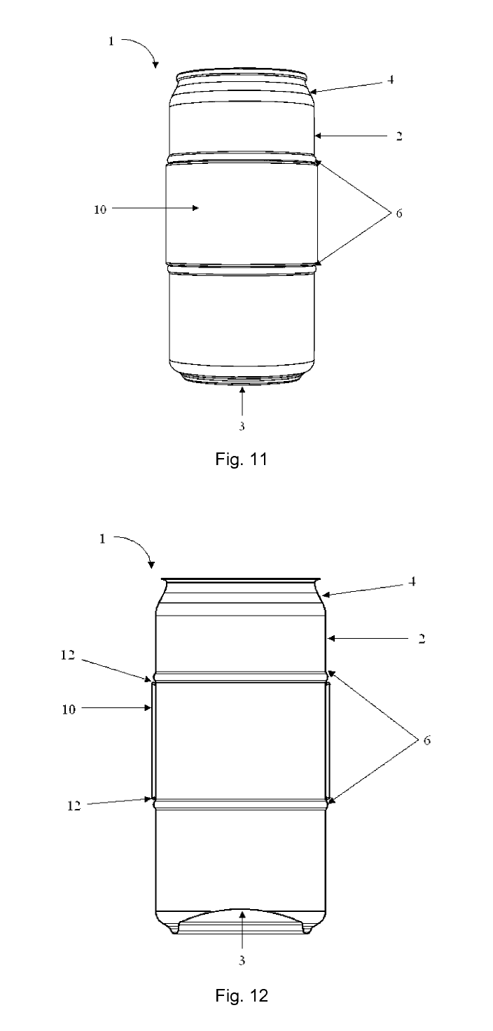

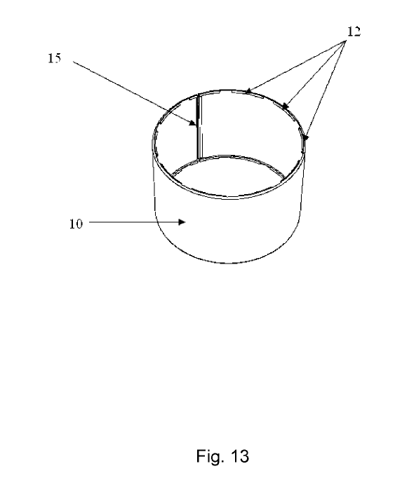

In a sixth embodiment of the invention (referring to FIGS. 11, 12 and 13) a separate hand insulating band 10 is fixed to the can body 1 using beads 12, extending around the external circumference of the can body 1. A plurality of spacer elements 12 are provided around the internal circumference of the band 10 to hold the band (which is designed to be held by a user) spaced from the sidewall 2 of the can body 1. This space or air gap insulates the sidewall 2 of the can body 1 from the heat of a users hand. The insulating band 10 may be made from any rigid material, including metal, because it is the air gap that provides the insulation. The band 10 may be provided with a join or seam 15 to enable it to be fitted easily around the circumference of the can body 1.

The “stay cool” can may be further enhanced by the provision of a visual clue to a user about where to place a hand whilst drinking, for example by printing finger and or thumb marks on the band 10.

Additionally, thermochromic inks may be applied to the sidewall of the can body to further enhance a user's perception that the can is cold. This would not be possible with a can that has all-over insulation, as suggested in the prior art.

Finally, it will be apparent to those skilled in art how the insulating band concept according to the present invention may be enhanced, whilst keeping to the spirit of the present invention. For example, the vertical position of the band on the sidewall of the can may be optimised by considering the mobility of the can body through the filling line versus ergonomics and the centre of gravity of a filled can during drinking.

1. A method of manufacturing a beverage can body with integral hand insulation band or insulation band portions comprising the steps of:
manufacturing a metal can body having a base, a sidewall extending upwardly from the base to an open top, and
forming an insulation band or insulation band portions, arranged to separate a user's hand from the sidewall (2) of the can body during use, the insulation band or band portions extending over only a portion of the sidewall and capable of providing insulation to a user's hand from the chilled contents after the can body is filled and seamed.

2. A method of manufacturing a beverage can body as claimed in claim 1, wherein the insulation band or portions covers a height range of no more than 100 mm.

3. A method of manufacturing a beverage can body as claimed in claim 2, wherein the hand insulation band is provided by a label, which is wrapped around the an outside circumference of the can body.

4. A method of manufacturing a beverage can body as claimed in claim 2, wherein the can body and the hand insulation band or portions together define gas pockets, which are adapted to insulate the sidewall of the can body from a user's hand during use.

5. A method of manufacturing a beverage can body as claimed in claim 4, wherein the sidewall of the can body is shaped to define the gas pockets.

6. A method of manufacturing a beverage can body as claimed in claim 4, wherein the insulation band is shaped or embossed to define the gas pockets.

7. A method of manufacturing a filled and sealed beverage can, comprising the steps of:
manufacturing a metal can body having a base, a sidewall extending upwardly from the base to an open top, and an insulation band or insulation band portions that are arranged to separate a user's hand from the sidewall of the can body during use, the insulation band or band portions extending over only a portion of the sidewall;
filling the beverage can body with a product, and
sealing the filled beverage can body with an end (5),
whereby the filled and sealed beverage can is suitable for further processing and the insulation band or portions is capable of providing insulation to a user's hand from the chilled contents after the filling and sealing steps.

8. A beverage can body comprising:
a base,
a sidewall extending upwardly from the base to an open top, and
an insulation band or insulation band portions that are arranged to separate a user's hand from the sidewall of the can body during use,
the insulation band or band portions extending over only a portion of the sidewall and capable of providing insulation to a user's hand from the chilled contents after the can body is filled and seamed.

9. A beverage can body as claimed in claim 8, wherein the insulation band or portions covers a height range of no more than 100 mm.

10. A beverage can body as claimed in claim 9, wherein insulation band is provided by a label, which is wrapped around an outside circumference of the can body.

11. A beverage can body as claimed in claim 9, wherein the can body and the hand insulation band or portions together define gas pockets, which are capable of insulating the sidewall of the can body from a user's hand during use.

12. A beverage can body as claimed in claim 9, wherein the sidewall of the can body is shaped to define the gas pockets.

13. A beverage can body as claimed in claim 9, wherein the insulation band is shaped or embossed to define the gas pockets.

14. A beverage can body as claimed in claim 9, wherein the insulation band or portions covers a height range of no more than 50 mm.

15. A filled and sealed beverage can comprising:
a base,
a sidewall extending upwardly from the base,
an end seamed to enclose an upper end of the sidewall;
an insulation band or insulation band portions that is arranged to separate a user's hand from the sidewall of the can body during use,
the insulation band or band portions extending over only a portion of the sidewall and capable of providing insulation to a user's hand from the chilled contents after filling and sealing of the can.

16. A beverage can as claimed in claim 15, wherein the insulation band or portions covers a height range of no more than 100 mm.

17. A beverage can as claimed in claim 16, wherein insulation band is provided by a label, which is wrapped around an outside circumference of the can body.

18. A beverage can as claimed in claim 16, wherein the can body and the hand insulation band or portions together define gas pockets, which are capable of insulating the sidewall of the can body from a user's hand during use.

19. A beverage can body as claimed in claim 16, wherein the sidewall of the can body is shaped to define the gas pockets.

20. A beverage can as claimed in claim 16, wherein the insulation band is shaped or embossed to define the gas pockets.

21. A beverage can body as claimed in claim 16, wherein the insulation band or portions covers a height range of no more than 50 mm.

22. A method of manufacturing a filled and sealed beverage can as claimed in claim 7 further comprising the step of further processing the can after the filling and sealing steps.

23. A method of manufacturing a filled and sealed beverage can as claimed in claim 7, wherein the insulation band or portions covers a height range of no more than 100 mm.

24. A method of manufacturing a filled and sealed beverage can as claimed in claim 7, wherein the hand insulation band is provided by a label, which is wrapped around an outside circumference of the can body.

25. A method of manufacturing a filled and sealed beverage can as claimed in claim 7, wherein the can body and the hand insulation band or portions together define gas pockets, which are adapted to insulate the sidewall of the can body from a user's hand during use.

26. A method of manufacturing a filled and sealed beverage can as claimed in claim 7, wherein the sidewall of the can body is shaped to define the gas pockets.

27. A method of manufacturing a filled and sealed beverage can as claimed in claim 7, wherein the insulation band is shaped or embossed to define the gas pockets.

28. A method of manufacturing a filled and sealed beverage can as claimed in claim 21, wherein the insulation band or portions covers a height range of no more than 50 mm.

29. A method of manufacturing a beverage can body as claimed in claim 2, wherein the insulation band or portions covers a height range of no more than 50 mm.
